(19) United States
(12) Patent Application Publication
(10) Pub. No.: US 2014/0143466 A1
(43) Pub. Date: May 22, 2014

(54) COMPUTER CAPABLE OF PROTECTING CPU

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventor: SHAO-BO ZHANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/859,746

(22) Filed: Apr. 10, 2013

(30) Foreign Application Priority Data
Nov. 21, 2012 (CN) 2012104756076

(51) Int. Cl. G06F 13/24

(52) U.S. Cl. CPC G06F 13/24
USPC 710/260

(57) ABSTRACT

A computer includes a main board. The main board includes a CPU socket, a south bridge, and an embedded control chip. The embedded control chip comprises a first General Purpose Input/Output (GPIO) pin and a second GPIO pin. The first GPIO pin is connected to a SKTOCC# pin of the CPU socket, and the second GPIO pin is connected to a PWRBTN# pin of the south bridge. After the computer is powered on, when the first GPIO pin detects that the voltage of the SKTOCC pin is high, the embedded control chip determines that there is no CPU in the CPU socket, and transmits a control signal to the PWRBTN# pin via the second GPIO. The south bridge shuts down the computer upon receiving the control signal

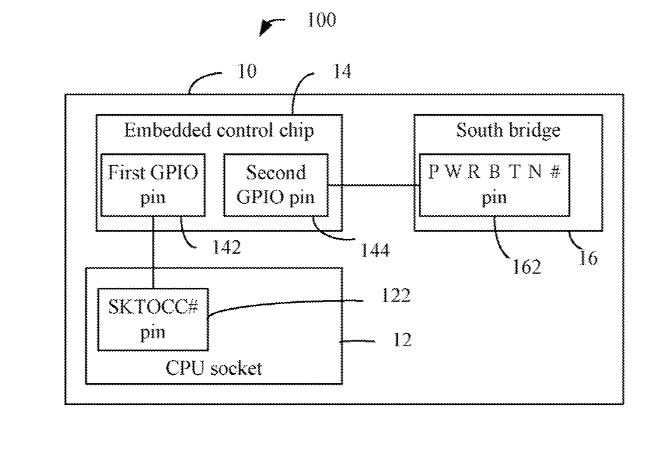

### BACKGROUND

1. Technical Field

The present disclosure relates to computers, and particularly, to a computer capable of protecting a Central Processing Unit (CPU) of the computer from damage caused by accidental hot plugging.

2. Description of Related Art

When testing a CPU, if the CPU is inserted to a CPU socket of a main board when the main board is still powered, the CPU is easily burnt out.

### BRIEF DESCRIPTION OF THE DRAWINGS

The components of the drawing are not necessarily drawn to scale, the emphasis instead being placed upon clearly illustrating the principles of the present disclosure.

The drawing is a block diagram of a computer capable of protecting a CPU of the computer from hot plugging damage, in accordance with an exemplary embodiment.

### DETAILED DESCRIPTION

Referring to the drawing, an embodiment of a computer 100 includes a main board 10. The main body 10 includes a CPU socket 12, an embedded control chip 14, and a south bridge 16. The embedded control chip 14 includes a first General Purpose Input/Output (GPIO) pin 142 and a second GPIO pin 144. The first GPIO pin is connected to a SKTOCC# pin 122 of the CPU socket 12. When the CPU socket 12 is not occupied by a CPU, the voltage of the SKTOCC# pin 122 is high. The second GPIO pin 144 is connected to a PWRBTN# pin 162 of the south bridge 162. After the computer 100 is powered on, when the first GPIO pin 142 detects that the voltage of the SKTOCC# pin 122 is high, the embedded control chip 14 determines that there is no CPU in the CPU socket 12, and transmits a control signal to the PWRBTN# pin 162 via the second GPIO pin. The south bridge 16 shuts down the computer 100 upon receiving the control signal. In this embodiment, the control signal is a level signal which changes from low to high.

With such configuration, the embedded control chip 14 can determine whether there is a CPU in the CPU socket 12. If there is no CPU in the CPU socket 12, the embedded control chip 14 signals the south bridge 16 to shut down the computer 100. Thus, when there is no CPU in the CPU socket 12, the computer 100 will automatically shut down. Thus, hot plugging can be avoided when inserting a CPU to the CPU socket 12, and burning out of the CPU can accordingly be avoided.

Although the SKTOCC disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A computer comprising:
a main board, wherein the main board comprises a Central Processing Unit (CPU) socket, a south bridge, and an embedded control chip, the embedded control chip comprises a first General Purpose Input/Output (GPIO) pin and a second GPIO pin, the first GPIO pin is connected to a SKTOCC# pin of the CPU socket, the second GPIO pin is connected to a PWRBTN# pin of the south bridge, after the computer is powered on, when the first GPIO pin detects that the voltage of the SKTOCC# pin is high, the embedded control chip determines that there is no CPU in the CPU socket, and transmits a control signal to the PWRBTN# pin via the second GPIO, the south bridge shuts down the computer upon receiving the control signal.

2. The computer as described in claim 1, wherein the control signal is a level signal which changes from low to high.

3. A main board of a computer comprising:
a Central Processing Unit (CPU) socket;
a south bridge; and
an embedded control chip;
wherein, the embedded control chip comprises a first General Purpose Input/Output (GPIO) pin and a second GPIO pin, the first GPIO pin is connected to a SKTOCC# pin of the CPU socket, the second GPIO pin is connected to a PWRBTN# pin of the south bridge, after the computer is powered on, when the first GPIO pin detects that the voltage of the SKTOCC# pin is high, the embedded control chip determines that there is no CPU in the CPU socket, and transmits a control signal to the PWRBTN# pin via the second GPIO, the south bridge shuts down the computer upon receiving the control signal.

4. The main board as described in claim 3, wherein the control signal is a level signal which changes from low to high.
